(19) United States
(12) Patent Application Publication
(10) Pub. No.: US 2008/0116272 A1
(43) Pub. Date: May 22, 2008

(54) Value Document with Luminescent Properties

(76) Inventors: Thomas Giering, Kirchseeon (DE); Gerhard Schwenk, Puchheim (DE); Wolfgang Rauscher, Munchen (DE); Oliver Martin, Chamalieres (FR); Yannick Mechine, Saint-Julien de Coppel (FR); Lysis Cubieres, Clermont-Ferrand (FR)

Correspondence Address: BACON & THOMAS, PLLC, 625 SLATERS LANE, FOURTH FLOOR, ALEXANDRIA, VA, 22314, US

(21) Appl. No.: 11/660,809

(22) PCT Filed: Sep. 1, 2005
(86) PCT No.: PCT/EP05/09435

§ 371 Date: Aug. 3, 2007

(30) Foreign Application Priority Data
Sep. 2, 2004 (EP) 04 020 881.1
Oct. 14, 2004 (EP) 04 024 533.4
Oct. 14, 2004 (EP) 04 024 534.2
Oct. 14, 2004 (EP) 04 024 535.9

(51) Int. Cl. G06K 7/01; G06K 19/06

(52) U.S. Cl. 235/439; 235/491

(57) ABSTRACT

The invention relates to a luminescent security feature system, a substrate having said luminescent security feature, and an apparatus and method for checking the luminescent security feature.

The invention is characterized in that, among other things, the security feature comprises at least two luminescent materials which produce corresponding, overlapping emission peaks in response to an excitation radiation.

This invention relates to a luminescent security feature whereby the security feature emits luminescence radiation upon excitation.

The invention likewise relates to a substrate having said luminescent security feature.

The invention relates further to an apparatus and a method for checking a luminescent security feature of a substrate to permit e.g. the authenticity of the substrate to be determined.

The use of luminescent substances for marking bank notes has been known for some time. In particular, with simultaneous use of different luminescent substances in an object to be secured these independent markings were also evaluated independently of each other. The precondition for this was that the different substances emitted in different spectral ranges. In particular, substances were used that emitted in the visible upon excitation with ultraviolet light or infrared light, such as up conversion luminescent materials or europium-doped yttrium vanadate or manganese-doped silicate.

For securing the corresponding object the luminescent materials were printed on the supporting material or incorporated therein, for example worked into paper or also into security elements, such as security threads or mottling fibers.

Even when several luminescent substances were used simultaneously the individual emissions of the substances were evaluated independently of each other, or when luminescences overlapped the evaluation was prevented completely. This makes it easier for forgers, firstly, to detect single luminescent spectral bands located far apart spectrally and, furthermore, to be able to imitate them with merely similar substances.

Another known idea is to use the presence and absence of clearly separate luminescent spectral bands upon superimposition of different spectra for a coding in order to increase the number of distinguishable codings. The different codings thus permit e.g. the denominations or also currencies to be distinguished. However, the spectral coding with clearly separate luminescent spectral bands has the disadvantage that the forger can again easily analyze the latter and when analyzing several bank notes can also easily determine the coding, e.g. for the individual denominations.

EP 1 182 048 discloses for example a method for authenticating a security document wherein the emission of a luminescence feature is already coded and said emission is compared with a reference spectrum.

Besides this approach there are numerous other systems for automatically checking bank notes. The associated sensors have become increasingly widespread within the last few years since not only, as before, the central banks issuing the currencies, but increasingly also commercial banks and trade employ devices for automatically checking bank notes, such as counting apparatuses, sorting apparatuses or money depositing machines or vending machines.

This increasing spread of sometimes high-quality bank note sensors even outside the bank sector involves the disadvantage, however, that forgers are also increasingly able to procure such sensors and can specifically adapt their forgeries by evaluating the measuring signals of said sensors.

To solve this problem, WO 97/39428 proposes that a bank note should contain a high security feature consisting of a mixture of two different substances incorporated in or applied to the paper, and a low security feature consisting of another substance. It is described that the high security feature is checked in a high security area, such as a bank, while only the low security feature is checked in a low security area, such as in publicly accessible vending machines.

However, this incorporation of different feature substances for different security categories increases the effort for a suitable selection of fitting feature substances and thus for the production of the associated value documents.

Therefore there is a need for an alternative system for securing currencies against forgeries which also takes into account the above-mentioned problems resulting from the increasing spread of bank note sensors.

The problem of the present invention is therefore to increase the falsification security of bank notes or other security documents.

The problem of the present invention is solved by the main claim and the other independent claims.

It should be emphasized that the features of the dependent claims and the embodiments stated in the following description can be used advantageously in combination or also independently of each other and of the sub-ject matter of the main claims.

Substrates according to the invention are typically security documents such as bank notes or checks, value documents made of paper and/or polymer such as passports, security cards such as ID or credit cards, labels for securing luxury goods, etc.

According to the invention the definition for substrates also covers possible intermediate products on the way to the security document. These are e.g. supporting materials with a security feature that are applied to or incorporated in an end substrate to be secured. For example, the supporting material can be a film element, such as a security thread, having the security feature.

The supporting material itself is connected to the object, such as a bank note, in the known way.

According to the invention the formulation “substrate having a security feature” means that the security feature is connected to the substrate in all sorts of ways. This is done in the following manner.

The security feature can be applied to the substrate, e.g. directly by printing, spraying, spreading, etc., or indirectly by gluing or laminating a further material equipped with the feature to the substrate.

Alternatively, the security feature can be incorporated into the substrate itself, i.e. it can be incorporated into the volume of the paper or polymer substrate. For example, the security feature can be mixed with the paper pulp during papermaking, or it can be added to the plastic during extrusion of films.

The term “radiation” is not restricted to visible (VIS) radiation but includes other kinds of radiation such as radiation in the infrared (IR) or near infrared (NIR) spectrum or in the UV spectrum. Combinations of said kinds of radiation are also intended by the term “radiation” here. This applies to both excitation and emission radiation.

Preferably, the excitation is effected with radiation in the invisible spectral range, particularly preferably with IR, NIR or UV radiation or combinations thereof.

The term “response signal” refers to radiation that is emitted by the luminescent security feature when it is irradiated with excitation radiation. The response signal typically lies in the invisible spectrum and can be present for example in the IR, NIR and/or UV spectrum or combinations thereof. The response signal is represented in the form of an emission spectrum, i.e. luminescence intensity versus emission wavelength.

Alternatively, the response signal is represented in the form of an excitation spectrum, i.e. luminescence intensity versus excitation wavelength. Further embodiments and advantages of the invention can be found in the following description and the figures, in which:

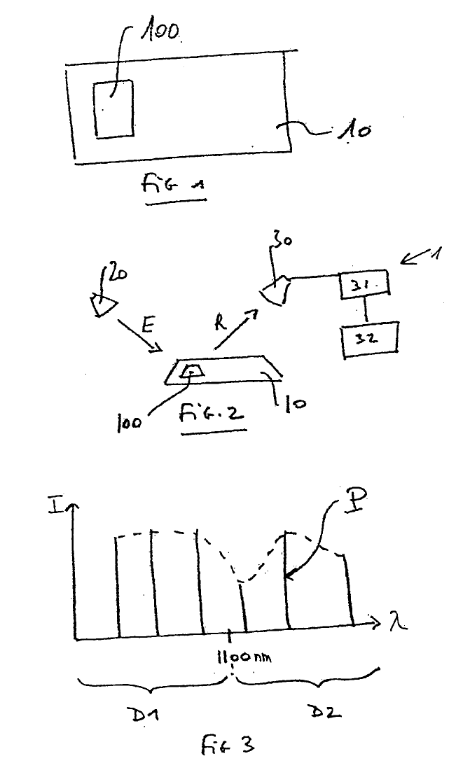

FIG. 1 shows a schematic representation of a substrate according to the present invention,

FIG. 2 shows a schematic view of a reading device for reading a luminescence security feature, connected to such a substrate,

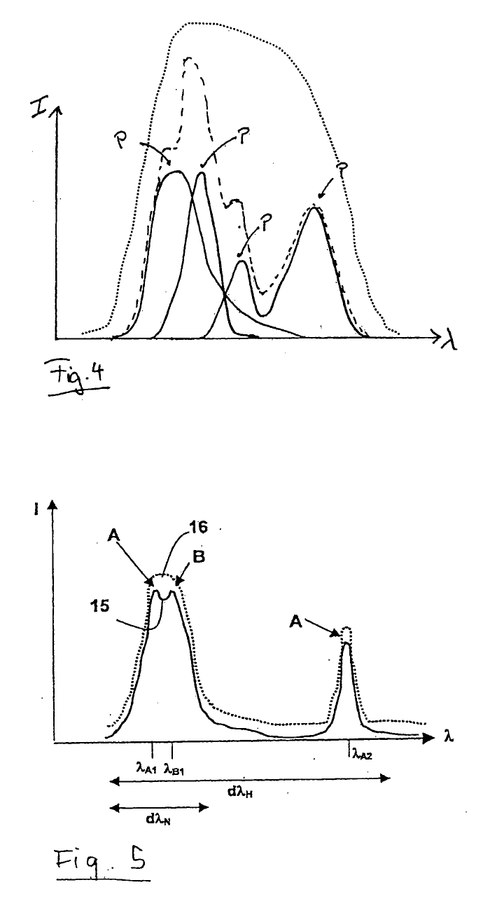

FIG. 3 shows a schematic example of a response signal of such a luminescent security feature,

FIG. 4 shows a further schematic example of a response signal of a luminescent security feature,

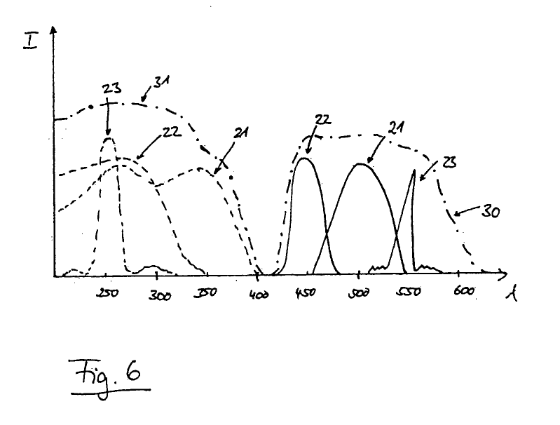

FIG. 5 shows a further schematic example of a response signal of a luminescent security feature, and

FIG. 6 shows yet another schematic example of a response signal of a luminescent security feature.

### General Remarks

FIG. 1 shows a substrate 10, which is a bank note 10 here by way of example.

As mentioned above, the substrate 10 can likewise be any other type, including substrates for intermediate products in the form of a supporting material, such as a film or a thread, which is connected to the end substrate to be secured. The substrate 10 comprises a luminescent security feature 100.

The feature 100 can be connected to the substrate 10 in any way, as mentioned above.

The feature 100 comprises luminescent feature substances which emit luminescence radiation in response to excitation radiation. This response contains information, based on the spectral distribution of the response and/or the excitation (e.g. distribution of the intensity of the response in the wavelength range).

### Materials of Luminescence Feature

The luminescent security feature 100 preferably comprises at least two luminescent materials whose emission and/or excitation spectra differ and whose response signals are spectrally adjacent.

The excitation and the emission of the luminescent substances can be effected in the UV, in the VIS and/or in the IR. In the following IR will also include NIR.

For example, substances can be used that are excited in the UV and emit in the visible spectral range, such as europium-doped yttrium vanadate Eu:YVO₄, manganese-doped silicate, etc. It is further possible to use luminescent substances that are excited in the visible and emit in the visible. It is further possible to use substances that are excited in the visible and emit in the infrared. It is further possible to use substances that are excited in the infrared and emit in the visible, such as up conversion luminescent materials. Luminescent substances that are excited in the UV and also emit in the UV are preferred. Substances that are excited in the infrared and emit in the infrared are further preferred.

### Examples of Excitation in the UV—Emission in the VIS (UV-VIS)

The following can be used according to the invention as substances that are excited in the ultraviolet (UV) and emit in the visible (VIS):

TABLE 1

| | Emission peak |
|---|---|
| Compound | λₘₐₓ [nm] |
| Mn:Zn₂SiO₄ | 520 |
| Ag,Ni:ZnS | 460 |
| Eu:YVO₄ | 632 |
| Eu:chelate | 600 |
| Mn,Pb:CaSiO₃ | 610 |
| Mn:KMgF₃ | 596 |
| Pr:Y₂O₂S | 515 |
| Tb:Y₂O₂S | 544 |
| Tb:La₂O₂S | 548 |
| Ce:Y₂SiO₅ | 415 |
| Dy:YVO₄ | 570 |
| Ti:Ba₂P₂O₇ | 500 |

### Examples of Excitation in the VIS—Emission in the IR (VIS-IR):

The following can be used according to the invention as substances that are excited in the visible (VIS) and emit in the infrared (IR)
   Er:Gd₂O₂S,
   Er:NaYW₂O₆,
   Yb,Er:CaF₂.
Said substances are excited at approx. 550 nm and emit at approx. 1100 nm.

### Examples of Excitation in the IR—Emission in the VIS (IR-VIS)

Substances that are excited in the infrared (IR) and emit in the visible (VIS) are so-called up conversion substances. According to the invention one can use
   Yb,Er:Y₂O₂S,
   Yb,Er:YVO₄,
   Yb,Er:ZBLAN glass.

### Examples of Excitation in the UV—Emission in the UV (UV-UV)

The following can be used according to the invention as substances that are excited in the ultraviolet (UV) and emit in the ultraviolet (UV):
   Ce:YPO₄ (emission peak at 380 nm)
   Pr:GdBO₃ (emission peak at 312 nm)
   Ce:SrAl₁₂O₁₉ (emission peak at 305 nm)
   Pb:BaSi₂O₅ (emission peak at 350 nm)
   Eu:SrBeO₇ (emission peak at 370 nm)

### Examples of Excitation in the IR—Emission in the IR (IR-IR)

The following can be used according to the invention as substances that are excited in the infrared (IR) and emit in the infrared (IR):
   Er:CaF₂
   Er:LiYF₄
   Er:KY(WO4)₂
   Er:YAG
whereby these are excited at approx. 850 nm and emit at approx. 1500 nm.
It is likewise possible to use
   Nd:Y₃Ga₅O₁₂
   Nd:KY(WO₄)₂
   Nd:SrAl₁₂O₁₉
   Nd:ZBLAN
whereby these are excited at approx. 800 nm.
It is likewise possible to use:
   Pr:SrMoO₄ which emits at approx. 1040 nm,
   V:MgF₂ which emits at approx. 1122 nm, and
   Ni:MgO which emits at approx. 1314 nm.

In particular, the substances to be used according to the invention are luminescent substances having a luminophore in a matrix. The luminophores may be either ions or molecules.

The luminophores are particularly preferably rare earth elements, e.g. La, Ce, Pr, Nd, Sm, Eu, Gd, Th, Dy, Ho, Er, Tm, Yb, Lu, or else ions of Bi, Pb, Ni, Sn, Sb, W, Tl, Ag, Cu, Zn, Ti, Mn, Cr or V, as well as organic luminophores or any combinations thereof.

Examples of luminophores are the fluorophores listed in Table 2. The stated values for the excitation wavelength and the emission peak are approximate, since these values strongly depend on the matrix in which the fluorophores are embedded (solvent shift).

TABLE 2

| | Excitation | | | |
|---|---|---|---|---|
| Fluorophore | wavelength | | Emission peak | |
| Rhodamine 6G | 520 | nm | 560 | nm |
| Rhodamine 700 | 645 | nm | 644 | nm |
| Carbazine 720 | 650 | | 670 | |
| IR 125 | 800 | | 850 | |
| IR 144 | 760 | | 850 | |
| HDITCI | 780 | | 830 | |

Further Examples of organic luminophores are terphenyls, quarterphenyls, quinquephenyls, sexiphenyls, oxazoles, phenylfuran, oxadiazoles, stilbene, carbostyryl, coumarine, styryl-benzene, sulfaflavine, carbocyanin-iodide, fluoresceine, fluororole, fhodamine, sulforhodamine, oxazine, carbazine, pyridine, hexacyanine, styryls, phthalocyanine, naphthalocyanine, hexadibenzocyanine, dicarbocyanine.

Optionally, the organic luminophores should be stabilized by suitable methods if the stability is not sufficient for the application.

The matrices are in particular inorganic host lattices, such as YAG, ZnS, YAM, YAP, AlPO₅ zeolite, Zn₂SiO₄, YVO₄, CaSiO₃, KMgF₃, Y₂O₂S, La₂O₂S, Ba₂P₂O₇, Gd₂O₂S, NaYW₂O₆, SrMoO₄, MgF₂, MgO, CaF₂, Y₃GasO₁₂, KY(WO₄)₂, SrAl₁₂O₁₉, ZBLAN, LiYF₄, YPO₄, GdBO₃, BaSi₂O₅, SrBeO₇, etc.

Organic matrices such as PMMA, PE, PVB, PS, PP, etc., are also particularly suitable.

Preferably, inorganic luminescent substances which have rare earth elements in inorganic matrices are used. Particularly the following substances can be used:

RE:A₂O₃, wherein

### RE stands for one or more elements selected from the group Ce, Pr, Nd, Sm, Eu, Gd, Tb, Dy, Ho, Er, Tm, Yb,

### A stands for one or more elements selected from the group Y, La, Gd, Lu, Sc, Al, Hf.

RE:A₂O₂S, wherein

### RE stands for one or more elements selected from the group Ce, Pr, Nd, Sm, Eu, Gd, Tb, Dy, Ho, Er, Tm, Yb,

### A stands for one or more elements selected from the group Y, La, Gd, Lu.

RE:ADO₄, wherein

### RE stands for one or more elements selected from the group Ce, Pr, Nd, Sm, Eu, Gd, Tb, Dy, Ho, Er, Tm, Yb,

### A stands for one or more elements selected from the group Zn, Sn,

### D stands for one or more elements selected from the group Si, Ge.

RE:A₅D(EO₄)₃ or RE:A₂D(EO₄)₂, wherein

### RE respectively stands for one or more elements selected from the group Ce, Pr, Nd, Sm, Eu, Gd, Tb, Dy, Ho, Er, Tm, Yb,

### A respectively stands for one or more elements selected from the group Ca, Sr, Ba,

### D respectively stands for one or more elements selected from the group F, Cl, OH,

### E respectively stands for one or more elements selected from the group P, Sb, Bi, V, Nb, Ta.

RE:A₃D, wherein

### RE stands for one or more elements selected from the group Ce, Pr, Nd, Sm, Eu, Gd, Tb, Dy, Ho, Er, Tm, Yb,

### A stands for one or more elements selected from the group Li, Na, K,

### D stands for one or more elements selected from the group P, Sb, Bi, V, Nb, Ta.

RE:A₃D₂₋ₓE₃₊ₓO₁₂, wherein 0'≦x≦2 and

### RE stands for one or more elements selected from the group Ce, Pr, Nd, Sm, Eu, Gd, Tb, Dy, Ho, Er, Tm, Yb,

### A stands for one or more elements selected from the group Y, La, Gd, Lu,

### D stands for one or more elements selected from the group Al, Ga, Tl, Sc, Fe, Cr,

### E stands for one or more elements selected from the group Al, Ga, Ti, Fe.

RE:ADO₄, wherein

### RE stands for one or more elements selected from the group Ce, Pr, Nd, Sm, Eu, Gd, Tb, Dy, Ho, Er, Tm, Yb,

### A stands for one or more elements selected from the group Ca, Sr, Ba, Pb,

### D stands for one or more elements selected from the group Cr, Mo, W, S, Se, Te.

RE:AD(EO₄)₂, wherein

### RE stands for one or more elements selected from the group Ce, Pr, Nd, Sm, Eu, Gd, Tb, Dy, Ho, Er, Tm, Yb,

### A stands for one or more elements selected from the group Li, Na, K,

### D stands for one or more elements selected from the group Y, La, Gd, Lu,

### E stands for one or more elements selected from the group P, Cr, Mo, W, S, Se, Te.

RE:A₂DO₈, wherein

### RE stands for one or more elements selected from the group Ce, Pr, Nd, Sm, Eu, Gd, Tb, Dy, Ho, Er, Tm, Yb,

### A stands for one or more elements selected from the group Y, La, Gd, Lu,

### D stands for one or more elements selected from the group Cr, Mo, W, S Se, Te.

RE:ADE₂O₆, wherein

### RE stands for one or more elements selected from the group Ce, Pr, Nd, Sm, Eu, Gd, Tb, Dy, Ho, Er, Tm, Yb,

### A stands for one or more elements selected from the group Li, Na, K,

### D stands for one or more elements selected from the group Y, La, Gd, Lu,

### E stands for one or more elements selected from the group Mo, W.

RE:ADO₄, wherein

### RE stands for one or more elements selected from the group Ce, Pr, Nd, Sm, Eu, Gd, Tb, Dy, Ho, Er, Tm, Yb,

### A stands for one or more elements selected from the group Ce, Y, La, Gd, Lu,

### D stands for one or more elements selected from the group P, V, Sb, Nb, Ta.

RE:A₂DE0₈, wherein

### RE stands for one or more elements selected from the group Ce, Pr, Nd, Sm, Eu, Gd, Tb, Dy, Ho, Er, Tm, Yb,

### A stands for one or more elements selected from the group Y, La, Gd, Lu,

### D stands for one or more elements selected from the group Si, Ge, Sn,

### E stands for one or more elements selected from the group Cr, Mo, W.

RE:AD₅O₁₄, wherein

### RE stands for one or more elements selected from the group Ce, Pr, Nd, Sm, Eu, Gd, Tb, Dy, Ho, Er, Tm, Yb,

### A stands for one or more elements selected from the group Y, La, Ce, Gd, Lu,

### D stands for P.

RE:AD₁₂O₁₉, wherein

### RE stands for one or more elements selected from the group Ce, Pr, Nd, Sm, Eu, Gd, Tb, Dy, Ho, Er, Tm, Yb,

### A stands for one or more elements selected from the group Y, La, Ce, Gd, Lu,

### D stands for one or more elements selected from the group Al, Ga, Tl, Sc.

RE:AD₄O₇, wherein

### RE stands for one or more elements selected from the group Ce, Pr, Nd, Sm, Eu, Gd, Tb, Dy, Ho, Er, Tm, Yb,

### A stands for one or more elements selected from the group Ca, Sr, Ba, Mg,

### D stands for one or more elements selected from the group Al, B.

RE:ADO₅, wherein

### RE stands for one or more elements selected from the group Ce, Pr, Nd, Sm, Eu, Gd, Tb, Dy, Ho, Er, Tm, Yb,

### A stands for one or more elements selected from the group Y, La, Gd, Lu, Sc,

### D stands for one or more elements selected from the group Si, Ge.

RE:ADTiO₆, wherein

### RE stands for one or more elements selected from the group Ce, Pr, Nd, Sm, Eu, Gd, Tb, Dy, Ho, Er, Tm, Yb,

### A stands for one or more elements selected from the group Y, La, Gd, Lu, Sc,

### D stands for one or more elements selected from the group Nb, Ta.

RE:AF₂ or RE:AD₂E₂G₃O₁₂ or RE:A₂DG₂O₇, wherein

### RE respectively stands for one or more elements selected from the group Ce, Pr, Nd, Sm, Eu, Gd, Tb, Dy, Ho, Er, Tm, Yb,

### A respectively stands for one or more elements selected from the group Ca, Sr, Ba,

### D respectively stands for one or more elements selected from the group Mg, Ca, Sr,

### E respectively stands for one or more elements selected from the group Y, La, Ce, Gd, Lu,

### G respectively stands for one or more elements selected from the group Si, Ge, Sn.

RE:ADO₄, wherein

### RE stands for one or more elements selected from the group Ce, Pr, Nd, Sm, Eu, Gd, Tb, Dy, Ho, Er, Tm, Yb,

### A stands for one or more elements selected from the group Li, Na, K,

### D stands for one or more elements selected from the group P, Nb.

RE:AE or RE:ADE₂ or RE:AO, wherein

### RE respectively stands for one or more elements selected from the group Ce, Pr, Nd, Sm, Eu, Gd, Tb, Dy, Ho, Er, Tm, Yb, Cu, Ag, Mn, Pb, Ni,

### A respectively stands for one or more elements selected from the group Zn, Cd,

### D respectively stands for one or more elements selected from the group Zn, Cd,

### E respectively stands for one or more elements selected from the group S, Se.

Ti:ADSiO₃, wherein

### A stands for one or more elements selected from the group Mg, Ca, Sr,

### D stands for one or more elements selected from the group Mg, Ca, Sr.

Ti:AD₂O₇, wherein

### A stands for one or more elements selected from the group Mg, Ca, Sr, Ba,

### D stands for one or more elements selected from the group P, Sb.

RE:A₃D₃O₉, wherein

### RE stands for one or more elements selected from the group Ce, Pr, Nd, Sm, Eu, Gd, Tb, Dy, Ho, Er, Tm, Yb,

### A stands for one or more elements selected from the group Y, La, Gd, Lu,

### D stands for one or more elements selected from the group Al, Ga, Sc.

RE:A₃(DO₄)₂, wherein

### RE stands for one or more elements selected from the group Cu, Ce, Pr, Nd, Sm, Eu, Gd, Tb, Dy, Ho, Er, Tm, Yb,

### A stands for one or more elements selected from the group Mg, Ca, Sr, Ba,

### D stands for one or more elements selected from the group P, Sb, Bi, V, Nb, Ta.

X:A₅D(EO₄)₃ or X:A₂D(EO₄)₂ or X:AG₂Al₁₆O₂₇ wherein

### X respectively stands for one or more elements selected from the group Mn, Eu,

### A respectively stands for one or more elements selected from the group Ca, Sr, Ba,

### D respectively stands for one or more elements selected from the group F, Cl, OH,

### E respectively stands for one or more elements selected from the group P, Sb, Bi, V, Nb, Ta,

### G stands for one or more elements selected from the group Mg, Ca, Sr, Ba.

Mn:A₃D, wherein

### A stands for one or more elements selected from the group Li, Na, K,

### D stands for one or more elements selected from the group P, Sb, Bi, V, Nb, Ta.

Mn:AD(EO₄) or Mn:A₂EO₄ or Mn:GEO₄, wherein

### A respectively stands for Zn,

### D stands for one or more elements selected from the group Be, Mg, Ca, Sr, Ba,

### E respectively stands for one or more elements selected from the group Si, Ge, Sn, Ti, Zr,

### G stands for one or more elements selected from the group Ge, Sn.

Mn:A₃(DO₄), wherein

### A stands for Zn,

### D stands for one or more elements selected from the group P, Sb, Bi, V, Nb, Ta.

Mn:ADO₃, wherein

### A stands for one or more elements selected from the group Mg, Ca, Sr, Ba,

### D stands for one or more elements selected from the group Si, Ge, Sn.

Eu:AB₄O₇ or Eu:A₂P₂O₇, wherein

### A respectively stands for one or more elements selected from the group Mg, Ca, Sr, Ba.

Eu:AB₄O₇ or Eu:ASO₄ or Eu:A₄Al₁₄O₂₅ or Eu:AAl₂Si₂O₈, wherein

### A respectively stands for one or more elements selected from the group Mg, Ca, Sr, Ba.

Eu:AD₃(EO₄)₂, wherein

### A stands for one or more elements selected from the group Mg, Ca, Sr, Ba,

### D stands for one or more elements selected from the group Mg, Ca, Sr, Ba,

### E stands for one or more elements selected from the group P, Sb, Bi, V, Nb, Ta.

Pb:AD₂O₅ or Pb:ADO₃, wherein

### A respectively stands for one or more elements selected from the group Mg, Ca, Sr, Ba,

### D respectively stands for one or more elements selected from the group Si, Ge, Sn.

Pb:A₂DSiO₇ or Pb:ASiO₃ or Pb:ASi₂O₇ or Pb:A₃Si₂O₇, wherein

### A respectively stands for one or more elements selected from the group Mg, Ca, Sr, Ba,

### D stands for one or more elements selected from the group Mg, Zn.

Pb:ADO₄, wherein

### A stands for one or more elements selected from the group Mg, Ca, Sr, Ba,

### D stands for one or more elements selected from the group Cr, Mo, W.

Bi:A₃ECl₆, wherein

### A stands for one or more elements selected from the group Li, Na, K, Cs,

### E stands for one or more elements selected from the group Y, La, Ce, Gd, Lu.

Bi:ABO₃, wherein

### A stands for one or more elements selected from the group Sc, Y, La.

Bi:ADB₄O₁₂, wherein

### A stands for one or more elements selected from the group Y, La, Ce, Gd, Lu,

### D stands for one or more elements selected from the group Al, Ga, Tl.

Bi:ADAlO₄ or Bi:DOCl or Bi:D₂O₃, wherein

### A respectively stands for one or more elements selected from the group Mg, Ca, Sr, Ba,

### D respectively stands for one or more elements selected from the group Y, La, Ce, Gd, Lu.

Bi₂Al₄O₉ or Bi₄AlGe₃O₁₂

Bi:ADO₄, wherein

### A stands for one or more elements selected from the group Y, La, Gd, Lu,

### D stands for one or more elements selected from the group P, V, Sb, Nb, Ta.

Sn:A₃(DO₄)₂ or Sn:A₂D₂O₇, wherein

### A respectively stands for one or more elements selected from the group Mg, Ca, Sr, Ba, Zn, Al,

### D respectively stands for one or more elements selected from the group P, Sb, Bi, V, Nb, Ta.

Sb:A₅D(EO₄)₃ or Sb:A₅₋ₓD₁₋ₓ(EO₄)₃(SbO)ₓ, wherein 0≦x≦0.1 and

### A respectively stands for one or more elements selected from the group Ca, Sr, Ba,

### D respectively stands for one or more elements selected from the group F, Cl, OH,

### E respectively stands for one or more elements selected from the group P, Sb, Bi, V, Nb, Ta.

W:AWO₄, wherein

### A stands for one or more elements selected from the group Mg, Ca, Sr, Ba.

Tl:A(DO₄)₂, wherein

### A stands for one or more elements selected from the group Mg, Ca, Sr, Ba, Zn,

### D stands for one or more elements selected from the group P, Sb, Bi, V, Nb, Ta.

Ni:AO, wherein

### A stands for one or more elements selected from the group Mg, Ca.

V:AF₂, wherein

### A stands for one or more elements selected from the group Mg, Ca, Sr.

V:A₂D₃F₁₉, wherein

### A stands for one or more elements selected from the group Mg, Ca, Sr, Ba,

### D stands for one or more elements selected from the group Y, La, Gd, Lu.

V:AD₅O₁₄, wherein

### A stands for one or more elements selected from the group Y, La, Gd, Lu, Ce,

### D stands for one or more elements selected from the group P, Sb.

V:ADE₄O₁₂, wherein

### A stands for one or more elements selected from the group Li, Na, K,

### D stands for one or more elements selected from the group Y, La, Gd, Lu, Ce,

### E stands for one or more elements selected from the group P, Sb.

V:AD₄(EO₄)₃O, wherein

### A stands for one or more elements selected from the group Mg, Ca, Sr, Ba,

### D stands for one or more elements selected from the group Y, La, Gd, Lu,

### E stands for one or more elements selected from the group Si, Ge, Sn, Pb.

RE:glass, wherein

### RE stands for one or more elements selected from the group Ce, Pr, Nd, Sm, Eu, Gd, Tb, Dy, Ho, Er, Tm, Yb,

glass stands for ZBLAN, AZF, Ca-aluminate-glass, fluoride glass, fluorphosphate glass, silicate-glass, sulfide-glass, phosphate-glass, germanate-glass.

### Example for Producing Organic System:

For producing organic luminescent substances that can be used according to the invention, the fluorophore is dissolved in the organic matrix, polymerized completely and freeze-ground. The thus produced pigments can then be processed further, by optionally adding TiO₂ and mixing with binder to provide a printing ink.
Alternatively, an undoped matrix can be produced in powder form in a first step, and processed under pressure in the autoclave together with the fluorophore in a second step.

Of the possible luminophores and matrices, rare earth elements as a luminophore are preferably combined with inorganic matrices, and organic luminophores combined with organic matrices.

However, it is also conceivable to use chelates as a luminescent substance, whereby e.g. a rare earth element is integrated in an organic cage here.

For producing the emission spectra overlapping according to the invention, rare earth based systems are preferably used. These are systems that are based on the luminescence of rare earth ions inserted into a host lattice, a so-called “matrix”.

The at least two luminescent substances with overlapping emission spectra preferably have the same matrix but a different luminophore here, or alternatively a different matrix with the same luminophore.

If one uses only one luminophore in different host lattices, the host lattices can differ in crystallographic configuration and/or in chemical composition.

Alteration of the crystallographic structure and/or the chemical composition of the host lattice, however, causes the spectra of said luminescent substances to differ only to a small measure, so that they overlap spectrally according to the invention.

The matrices can firstly have the same chemical composition (e.g. produced from the same chemical elements, generally with different contents of said elements), but with different crystallographic configurations.

Such matrices form a family of matrices which are very similar chemically but differ in their crystallographic structures. Examples of such a family include YAG (Y aluminum garnet Y₃Al₅O₁₂) matrices and YAM (monoclinic yttrium aluminate Y₄Al₂O₉) matrices.

If a forger tried to determine the luminescent feature by chemical analysis to forge the substrates by imitating the feature, he could possibly analyze the individual elements but the corresponding crystallographic configurations of the matrices would be left out of consideration. The forger would suspect that only one matrix was present in the luminescence feature. If he left the corresponding crystallographic structures of the different matrices in the authenticity feature out of consideration when reproducing the feature, the imitated luminescent feature would not contain at least two luminescent materials but only one.

Secondly, the matrices can have the same crystallographic configuration but a different chemical composition.

Such matrices can be produced for a given crystallographic structure, comprising atoms or groups of atoms selected from e.g. O, N, C, Y, Al, Fe, Cr, P, W, Si, Zn, Gd, Ga, S, La, Ca.

Advantageously, narrowband luminescent substances are used according to the invention. In a particularly advantageous embodiment, said narrowband luminescent substances are combined with luminescent substances that emit broadband radiation and luminesce in the same wavelength range as the narrowband luminescent substance. The broadband luminescent substances that can be used are either inorganic or organic substances. It is of course also possible according to the invention to use substances that exhibit only broadband luminescence.

From the now possible large number of luminescent substances, corresponding luminescent substances are selected so that the emission spectra of at least two substances overlap spectrally. FIG. 4 shows schematically a spectrum (luminescence intensity versus wavelength) wherein several substances with single spectral bands P in combination form the luminescence feature 100, the envelope of the total luminescence feature being shown by the dashed line.

Such systems cannot be spectrally separated exactly using commercially available spectrometers, in particular when the luminescent substances contained therein are present jointly in a security feature in the concentrations that are low for security applications, and furthermore only short measurement times might be available. Due to the overlap of the spectra the analysis yields, instead of well separated individual spectra, spectra that are poorly or not structured spectrally (broadband envelope), which are very difficult to interpret. Such a broadband envelope is shown by the dotted line in FIG. 4. In the ideal case the identification of the single substances per se is ruled out. This makes it very difficult or impossible for the forger to analyze and interpret the inventive combination.

According to the invention, the term “overlap of spectra” refers to at least two spectral bands of different substances which overlap essentially, i.e. the spectral bands cannot be analysed independently from each other. Thus, a complete separation of the individual spectral bands is not possible. The resolution of the measurement is typically about 10 to 15 nm.

The term “broadband” refers to a response signal represented by a broad-band envelope which is not structured so that spectral details of overlapping spectra are not resolved (see e.g. dotted line in FIG. 4).

The term “narrowband” refers to a response signal represented by a spectral finger print, i.e. spectral details of overlapping spectra can be analysed (see e.g. dashed line in FIG. 4). Narrow spectral bands preferably have a FHWM of about 50 nm or smaller, e.g. regarding organic systems or Uv-VIS systems. More preferably, the narrow spectral bands have a FHWM of about 15 nm or smaller, e.g. regarding rare earth systems.

Alternatively, an overlap of the excitation spectra can be used instead of the overlap of the emission spectra.

In a further advantageous embodiment, not only the emission spectra but also the excitation spectra overlap.

The complexity of the security feature can be increased further if not only two substances of the security feature overlap spectrally, but if the number of substances is increased further. This makes it possible to provide luminescent security features that cover a wide wavelength range. Within this wavelength range many different combinations of codings can then be created due to the differing spectra.

According to the invention an overlap of at least two spectra is present in at least one spectral range. This area will also be designated the overlap area in the following.

It is of course also possible to form the total spectrum so that said overlap area is combined with a further spectrum not overlapping with the overlap area. The spectral bands of said further spectrum thus lie in another spectral range which can directly adjoin the first overlap area or else be spaced therefrom. The further spectrum can itself again consist of a combination of overlapping spectra of different substances so that a second overlap area is present, or else be the spectrum of a single substance.

In further embodiments it is also possible to combine more than two of the spectral ranges just stated.

However, it is preferable to combine spectral ranges that are not directly adjacent but are wavelength ranges apart. For example, one spectral range lies in the visible while the other spectral range lies in the infrared. It is particularly preferred here if different radiations are used for exciting the two spectral ranges, such as excitation with UV radiation/emission in the visible and excitation in the visible/emission in the infrared.

### Example of Inorganic Security Feature with Two Luminescent Substances (Excitation in the UV—Emission in the VIS):

In one embodiment, powdered Mn:Zn₂SiO₄ is mixed with powdered

Pr:Y₂O₂S and added to the paper pulp during papermaking. Upon irradiation of the finished paper with UV radiation, Mn:Zn₂SiO₄ luminesces at 520 nm and Pr:Y₂O₂S at 515 nm.

### Example of Inorganic Security Feature with Three Luminescent Substances (Excitation in the UV—Emission in the VIS):

In a further embodiment, powdered Tb:La₂O₂S, powdered Tb:Y₂O₂S and powdered Ag,Ni:ZnS are mixed. The powder mixture is processed to a printing ink and printed on security paper. Upon irradiation of the print with UV radiation the three compounds luminesce at the values stated in the table, whereby the three luminescent spectral bands overlap.

### Example of Inorganic Security Feature with Three Luminescent Substances (Excitation in the IR—Emission in the IR):

In a further embodiment, powdered Er:LaPO₄, powdered Er:Gd PO₄ and powdered Er:CePO₄ are mixed. The luminescent substances have the same luminophore but have different matrices. The powder mixture is processed to a printing ink and printed on security paper. Upon irradiation of the print with IR radiation the three compounds luminesce in the IR, whereby the three luminescent spectral bands overlap.

### Example of Inorganic Security Feature with Two Luminescent Substances (Excitation in the IR—Emission in the IR):

In a further embodiment, powdered Er:YAl₁₂O₁₉ and powdered

Er:GdAl₁₂O₁₉ are mixed. The luminescent substances have the same luminophore but have different matrices. The powder mixture is processed to a printing ink and printed on security paper. Upon irradiation of the print with IR radiation the two compounds luminesce in the IR, whereby the luminescent spectral bands overlap.

According to the invention it is alternatively possible to combine the luminescent substances so that the different substances are excited by radiation in different spectral ranges and/or emit in different spectral ranges, for example substances that are excited in the UV and emit in the VIS can be combined with substances that are excited in the visible and emit in the visible. If the spectral ranges of these substance combinations are adjacent, very compact sensors can be produced because the spectral separation can be performed with a single element, e.g. a spectrometer or filter systems, that cover or covers both wavelength ranges of the combinations.

According to the invention, overlapping combinations of single substances are located at least in one of said wavelength ranges. It is at first possible that such overlapping combinations in one spectral range are combined with pure spectra (i.e. spectra of pure substances) in another spectral range. This permits the number of distinguishable single substances to be greatly increased, whereby the security is additionally increased over systems today available.

### Example of Inorganic Security Feature with Three Luminescent Substances (Excitation in the UV—Emission in the UV and VIS:

Powdered Ce:YPO₄ (emission peak at approx. 380 nm), powdered

Ti:Ba₂P₂O₇ (emission peak at approx. 500 nm) and powdered Mn,Pb:CaSiO₃ (emission peak at approx. 610 nm) are mixed. The powder mixture is processed to a printing ink and printed on security paper. Upon irradiation of the print the three compounds luminesce at the stated values in the UV and VIS, whereby the luminescent spectral bands of Ti:Ba₂P₂O₇ and Mn,Pb:CaSiO₃ overlap in the VIS, while Ce:YPO₄ luminesces as an single substance in another spectral range (UV). By variation of the single substance it is thus possible to increase systematically the number of available systems. It is furthermore conceivable, however, to use combinations overlapping in both spectral ranges, i.e. also in the UV.

A development according to the invention is likewise to combine two or more wavelength ranges in which overlapping single substances are located, in the borderline case over the total available spectral range of luminescent substances. It is then selectable for each single spectral range whether single substances or combinations of overlapping spectra are used as long as at least one spectral range shows overlapping spectra.

It is of special advantage for increasing security according to the invention if substances are combined whose excitation and/or emission spectra are not adjacent but spaced apart by wavelength ranges, for example excitation in the UV/emission in the VIS combined with excitation in the VIS/emission in the IR.

It is of special advantage here if different technologies are used for exciting the two spectral ranges. The same is of course also possible with the detector technologies, or even on the excitation side and emission side. Analogously this can of course also be applied in the NIR or IR. For example, systems can be used with wavelengths below or above 1100 nm, which are detectable or no longer detectable with detectors made of silicon. The effort of detecting such systems completely is considerably increased over conventional systems.

If these systems are not combined with each other—as usual—so that the developing narrowband lines do not overlap to permit them to be better separated spectrally, but just so that the narrowband lines overlap, the protection against analysis and imitations is better.

It is of special advantage, however, if the described narrowband luminescence systems are combined with very broadband luminescence systems that luminesce in the same wavelength range. In particular organic fluorescence systems are to be mentioned here, but also inorganic systems which emit broadband radiation, for example the well-known system ZnS:Cu.

### Example of Overlapping Excitation and Emission Spectra

According to an inventive embodiment, the three luminescent substances Mn:MgGa₂O₄ (21), Eu:Sr₂P₂O₇ (22) and YNBO₄:TB (23) are combined. For example the luminescent substances can be added in powder form to the paper pulp during papermaking or else be mixed with a binder for producing a printing ink.
FIG. 6 shows the excitation spectra (dashed lines) as well as the emission spectra (whole line) of the three luminescent substances. The emission peak of Eu:Sr₂P₂O₇ is at approx. 450 nm, the emission peak of Mn:MgGa₂O₄ at approx. 500 nm and the emission peak of YNBO₄:Tb at approx. 545 nm.
The excitation spectra are produced by irradiating the luminescent sub-stances with light sources of different wavelengths and ascertaining which radiation triggers luminescence. In the present example two UV lamps are used which emit at 254 and 365 nm, and three LEDs emitting at 380, 400 or 420 nm. The different light sources shine on the sample alternately so that the particular response signal can be determined.
With the use of the substances just stated, both the excitation and the emission spectra overlap, so that both spectra can be used for the inventive evaluation.

For the evaluation only the presence or absence of a signal in the corresponding spectral range can be determined, or else a resolution of the individual spectra is possible, depending on the user. Thus, a central bank can for example resolve both the excitation and the emission spectra, while e.g. a commercial bank can resolve the excitation spectrum but not the emission spectrum and can thus measure only an envelope 30 (dot-dash line) in the range around 500 nm. For vending machine manufacturers, only the information of the emission envelopes 30 and excitation envelopes 31 could be available.

### Example of Application of Overlapping and Non-Overlapping Emission Spectra:

If it is desirable to distinguish different denominations of a currency and additionally provide the different checking offices with different checking competences, this can be obtained for example with the following system.

TABLE 3

| | Ce:YPO₄ | Ce:Y₂SiO₅ | Ti:Ba₂P₂O₇ | Mn,Pb:CaSiO₃ |
|---|---|---|---|---|
| Denomination | First spectral range | | Second spectral range | |
| 10 | + | + | − | − |
| 20 | + | + | + | − |
| 30 | + | + | − | + |
| 40 | + | + | + | + |
| 50 | + | − | + | + |

The different denominations are distinguished fundamentally by the presence (+) or absence (−) of the luminescent substances listed in Table 3. Ce:YPO₄ has an emission peak of 380 nm, Ce:Y₂SiO₅ an emission peak of 415 nm, Ti:Ba₂P₂O₇ an emission peak of 500 nm and Mn,Pb:CaSiO₃ an emission peak of 610 nm. Two spectral ranges can thus be delimited from each other, the first spectral range reaching from approx. 300 to 450 nm and the second spectral range from approx. 450 to 650 mm.
The denomination 10 is characterized by two overlapping spectra in the first spectral range, whereby no signal is present in the second spectral range.
The denomination 20 is characterized by two overlapping spectra in the first spectral range, whereby a single spectral band of Ti:Ba₂P₂O₇ is present additionally in the second spectral range.
Denomination 30 is characterized by two overlapping spectra in the first spectral range, whereby a single spectral band of Mn,Pb:CaSiO₃ is present additionally in the second spectral range.
Denomination 40 is characterized in that two overlapping spectra are present both in the first and in the second spectral range.
Denomination 50 is characterized by a single spectral band of Ce:YPO₄ while two overlapping spectra are present in the second spectral range.
It is up to the system supplier to select which information about the individual spectral ranges he passes on to the users. For example, a central bank could be given all information about the specific presence of overlapping and non-overlapping spectra. The central bank would thus be able to ascertain for which denominations single spectral bands and/or overlapping spectra are present. From this information a possibly present coding can then be selected additionally. Commercial banks can be given only partial information. For example, a commercial bank can resolve the overlapping spectra in the first spectral range of the denominations 10 and 40, but only measure the envelope in the second spectral range for the denomination 40. Manufacturers of vending machines, for example, have access to even less information. Thus they cannot perform a resolution of overlapping spectra for any denomination, but can only ascertain the presence or absence of signals in the first and/or second spectral range. If it is desirable to reduce the information for the user even further it is possible, for denominations with signals in the first and second spectral ranges, to pass on only the information about the envelope exclusively for one range.
The possibilities of combination can be further increased e.g. by using further luminescence substances in the single spectral ranges, by utilizing further spectral ranges and by using dummy matrices, so that accordingly exclusive codings are available for a large number of applications.

### Coding:

According to a further idea of the present invention, the complex representation of the expected response signal can comprise more than one spectral band.

The spectral bands of said complex representation can form a code which is compared with a code formed by the spectral bands of the stored complex representation.

This code can be based on the particular wavelengths of the single spectral bands.

Alternatively, the code can be based on the particular intensities of the spectral bands.

A code can also be developed that is based both on the wavelengths and on the intensities.

It is of course possible here, too, to base the code only on the spectral bands of the emission spectra and/or excitation spectra.

Preferably, rare earth systems based on only one rare earth ion in different matrices will also be used for the inventive systems. For usual codings with luminescence spectrums such differences are far too small to allow a clean separation of the mutually independent single substances.

In the inventive system, however, precisely the overlap of the spectra of a rare earth ion in different matrices can be utilized for the coding.

In the simplest case an inventive combination then consists of a rare earth ion which is inserted into two different matrices which are embedded into the security element. Here, too, this type of coding can be performed either with the emission spectra or with the excitation spectra (or with both). Exact analysis even shows that rare earth ions are particularly well suited for this kind of coding since they have very narrowband spectra, and so many different inventive combinations in different wavelength ranges can be combined into a total system, which greatly increases the complexity of the feature system and thus the security vis-à-vis forgers.

### Luminescence Features with Several Excitation Wavelengths:

The security of the inventive system can be increased even further if not only the emission spectra overlap but also the excitation spectra.

In such a case it can be provided that two inventively overlapping systems are adjusted so that upon excitation with an excitation wavelength λ1 a given emission spectrum is adjusted. This is intended to mean that the emission spectrum corresponds to a given emission spectrum within the given tolerances. In this case it is particularly advantageous if different batches of the single substances are used whose excitation spectra differ.

This is possible with the same or similar chemistry since e.g. the particle size distributions of the powders differ from each other. Different batches of value documents are marked with the different batches of the substances. Upon analysis of the different batches of the value documents it is then ascertained that upon excitation with wavelengths λ unequal λ1 the emission spectra of the documents differ, thereby protecting the systematics of the coding from analysis. Only upon excitation with the specific wavelength λ1 does the system show the defined emission spectra. If unusual excitation wavelengths are used for detecting the system, this makes analysis of the system even more difficult.

The security of the inventive system can be furthermore increased even more by combining different inventive combinations that are “adjusted” to each other with different excitation wavelengths.

If the two inventive combinations K(1,2)=αA1+βA2+γA3 comprising the single substances A1, A2, A3 are combined, it can be provided that the emission spectra of the single substances A1 and A2 show a given emission spectrum at an excitation wavelength λ1, while the emission spectra of the single substances A2 and A3 show a given emission spectrum at an excitation wavelength λ2. The indices α, β and γ state the contents of the substances. Different batches of the single substances A1, A2 and A3 can be combined whose excitation spectra differ.

During production it is ensured that the overlapping spectrum of the single substances A1 and A2 corresponds to a given regularity for all batches of A1 and A2 (only) when excitation is effected at a wavelength λ1, while the overlapping emission spectra of the single substances A2 and A3 corresponds to a given regularity for all batches of A2 and A3 (only) when excitation is effected at a wavelength λ2 unequal λ1.

To obtain this goal a light source, e.g. the light source 20 explained more precisely hereinafter with respect to FIG. 2, must emit at least at the two excitation wavelengths λ1 and λ2. An extension to more than three single sub-stances is possible without qualification.

This principle is likewise applicable when the coding is not performed with the emission spectra but with the excitation spectra. In this case the response R must be detected with at least two wavelengths via which the single sub-stances can be adjusted to each other.

### Inactive Dummy Matrix

In any case the luminescence feature can furthermore comprise at least one inactive dummy matrix.

Such an inactive dummy matrix has the advantage of further confusing the forger wanting to perform a chemical analysis of the luminescence feature. An inactive dummy matrix consists e.g. exclusively of matrix material, i.e. the matrix contains no luminophore. Consequently the inactive dummy matrix does not show any luminescence effect when it is exposed to the excitation radiation. Alternatively, the dummy matrix contains the same luminophore as the luminescent substance, but the luminescence of the luminophore in the dummy matrix is prevented completely by small additions of so-called luminescence quenchers.

Such an inactive dummy matrix has a strong effect on the results of the analysis of the feature by the forger, but does not have any influence on the spectral emission characteristics of the feature.

The one or more inactive dummy matrices in the luminescence feature can, in an alternative embodiment, be different from the matrix or matrices that contain a luminophore and are optically active.

Besides the spectral analysis of the emission characteristics of the luminophores, the chemical composition of the security feature can also be determined by means of element analysis for checking authenticity.

To further increase security, the crystallographic configuration can furthermore be used as an authenticity feature. In particular the detailed analysis of the inactive dummy matrices can be suitable for authenticity verification of the substrate.

In a preferred embodiment, the security feature comprises at least two inactive dummy matrices, whereby said inactive dummy matrices form a code which can be determined by detailed analysis, as mentioned above.

### Example of Dummy Matrix and Application Thereof

In Table 4 different luminescent substances which were combined with one or two dummy matrices are used for marking three different denominations of a currency XY.

TABLE 4

| Denomination | Substance 1 | Substance 2 | Substance 3 |
|---|---|---|---|
| 10 | Yb,Er:Y₂O₂S | YVO₄ | ZBLAN |
| | (Lum. substance) | (Dummy matrix) | (Dummy matrix) |
| 20 | Yb,Er,Dy:Y₂O₂S | Yb,Er:YVO₄ | ZBLAN |
| | (Dummy matrix) | (Lum. substance) | (Dummy matrix) |
| 30 | Y₂O₂S | Yb,Er:YVO₄ | Yb,Er:ZBLAN |
| | (Dummy matrix) | (Lum. substance) | (Lum. substance) |

Denomination 10 contains as a luminescent substance Yb,Er:Y₂O₂S and two further substances, namely YVO₄ and ZBLAN, which function as dummy matrices. The latter do not luminesce themselves.

Denomination 20 contains as a luminescent substance Yb,Er:YVO₄ as well as the dummy matrices ZBLAN and Yb,Er,Dy:Y₂O₂S. In comparison with substance 1 of the denomination 10, substance 1 of the denomination 20 additionally contains DY which works as a quencher, so that substance 1 of the denomination 20 does not show any luminescence.

Denomination 30 contains two luminescent substances and one dummy matrix.

All substances used in the different denominations are advantageously very similar, so that an attempt at forgery is made considerably more difficult.

This example serves principally to illustrate the use of the dummy matrix. For the further implementation according to the invention, the luminescent substances should be selected so as to have overlapping spectra. The luminescent substances listed in Table 4 can therefore be supplemented or replaced in suitable fashion.

### Method for the Application of the Luminescence Features:

The application e.g. consists in incorporating the feature substances as powder mixture into a substrate (paper, polymer substrate, incl. polymer coating, incl. paper coating, cardboard, patches, threads, stickers, screen printing elements). The problem here is to incorporate the mixture of pigments into the substrate in such a way, that the information of the encoding is preserved.

Here the following processing stages are of interest for the application of the feature substances.

For creating the powder mixture (“code”) the powders are provided as raw powders and mixed in dry process by means of a mixer. Here it could be useful to add additives, that improve the miscibility.

Important is, that after the mixing the powder mixtures are checked in view of the code being present in the right mixture, i.e. that within predetermined tolerances the spectrum corresponds to the predetermined spectrum.

For that on a laboratory scale a security element or another corresponding element (e.g. doctor blade foil), which permits a quantitative comparison, is produced and compared to standards.

In the paper plant then the powder is dispersed in a large vessel and successively added in an appropriate fashion to the paper pulp.

### Quality Control During the Incorporation:

The process of incorporation into the substrate is monitored, i.e. a detector, which possibly measures more specific than the hereinafter described detectors for checking bank notes being in circulation, is moved across the paper web or the substrate in general, and proves that it is the right code. In this version the detector is only able to indicate the correspondence of the measured encoding with the predetermined encoding or its quality, but it does not intervene in a controlling or regulating fashion.

As to prevent a segregation of the individual substances of the powder during the incorporation, a metering station can be implemented, which assumes the following functions: For each individual substance of the powder a concentrate is produced, which is filled in different tanks in the metering station. Again a detector can be employed, which via a control system ensures, that the individual substances are apportioned correctly.

As a further design there is thinkable, that the main amount of the powder is charged as a ready mixture and only deviations from the desired value are fed via a metering station. As a result of this, such a metering station can be of a more compact design, because only the powder amounts for correcting purposes have to be provided.

At the end of this section two specific examples shall be explained in more detail:

### Detailed Example 1:

Cu:ZnS is a luminescence system with excitation in UV and a broad-band emission in the yellow-green wavelength range with emission spectrum S1_{—}365(λ) at excitation with λ=365 nm.

Mn:ZnSiO₄ on the other hand is a luminescence system with excitation in UV and emission in the red with emission spectrum S2_{—}365(λ) at excitation with λ=365 nm.

These two individual substances now are combined e.g. in a luminescence print, namely with an exactly predetermined concentration ratio, which is adjusted in such a way, that the spectrum to be achieved S_tot(λ)=α*S1_{—}365(λ)+β*S2_{—}365(λ) is adjusted by a selection of the parameters α and β within predetermined limits.

In the simplest case the system is adjusted in such a way, that at the usual excitation wavelength of 365 nm it leads to a defined emission spectrum. But, furthermore, it is conceivable and subject matter of the invention, that an unusual excitation wavelength, e.g. 254 nm is used, which also leads to luminescence emission of the individual substances.

Advantageous for the solution of the inventive problem, in different charges specific substances (e.g. Cu:ZnS) can be used, the ratio of the emission spectra A(365 nm)/A(254 nm) at λ=365 nm and λ=254 nm varying for different charges. This can be achieved e.g. by controlling the manufacturing conditions, for example the annealing time or by choosing the appropriate particle sizes. Thus, the intensity values at an excitation wavelength of 254 nm can be kept constant whereas they vary at 365 nm.

When analysing such systems, the encodings when illuminated with only one wavelength (here 365 nm) appear completely different, although the quality control is adjusted in such a way, that at excitation with the system wavelength (here 254 nm) the result is always the same spectrum s_tot(λ)=α′*S1_{—}254(λ)+β′*S2_{—}254(λ). When analysing a larger number of BN in this way, different spectra become obvious and to a forger it is not clear how he has to correctly adjust the ratios.

### Detailed Example 2:

As to broaden the detailed example 1, in addition other substances can be combined, e.g. Ag,Ni:ZnS. Here one notices a distinct overlap of the luminescence spectra.

With this additional combination a larger number of encodings can be produced with a predetermined number of substances. Additionally, the system becomes more and more complex, since an attacker who tries to imitate the system, cannot recognize at which wavelengths the spectra are adjusted to each other.

In the example 2 discussed here, several wavelengths can be used as well, i.e. for example the first two systems (from example 1) are adjusted to each other at 254 nm, while the 3rd system (Ag-codoped) is adjusted to one of the first two at a wavelength of 365 nm. It is also possible, that all three systems are adjusted to each other at the same wavelength.

### Checking of Luminescence Features

FIG. 2 in a very schematic way shows by way of example an apparatus for checking such a feature 100. Such apparatus can be employed e.g. in bank note counting apparatus or bank note sorting apparatus, bank note depositing machines or bank note dispensers or in vending machines or also in handheld checking devices.

In FIG. 2 the substrate 10 with the feature 100, i.e. e.g. a bank note 10, is irradiated by excitation radiation E, which is emitted by a light source 20 or by several light sources 20. When exposed to radiation the feature 100 emits a response signal R in the form of luminescence radiation.

This response signal R, i.e. the radiation coming from the bank note 10, is measured by a detector 30, which comprises one or several sensors so as to permit measuring in different spectral regions, the detector 30 preferably having a spectrometer. The detector 30 is connected to a processor unit 31, which is able to evaluate the information given by the luminescence response signal R. The processor unit 31 is connected to a storage unit 32, in which the expected response signals of real bank notes or quantities derived therefrom are stored as reference signals.

For the purpose of determining e.g. the authenticity and/or the denomination of the checked bank note 10, in the processor unit 31 the response signal R is compared to predetermined response signals or derived quantities that serve as reference signals and are stored in the storage unit 32.

The reading device 1 here can comprise, depending on the use, only the detector 30, or optionally also the further components 20, 31, 32 in one housing.

### Detection According to Different Security Categories:

One essential idea of the present invention is, that in areas with different security categories the checking of an identical luminescent security feature is carried out in different ways, using different sensor parameters for different security categories.

In contrast to the known system of WO 97/39428, wherein different sub-stances are used as security features for different security categories, according to the invention the same luminescent substance can be used for all security categories, the substance, however, has to be checked in different ways by the users in the areas of the different security categories.

According to the invention there can be provided that in accordance with respective standards specified by a central bank, a producer of sensors may provide for customers for the use in areas with low security category, such as e.g. for producing vending machines, which usually are put up without high security requirements and freely accessible for everybody, only such sensors which can measure the luminescence radiation of bank notes with a lower spectral resolution than sensors, which the producer of sensors may provide for customers, such as e.g. commercial banks with higher security category.

Accordingly, the high-quality sensors used by the central banks (highest security category) for checking bank notes being in circulation are exclusively provided for these and without their approval such sensors cannot be provided for any other institution.

This inventive proceeding results in the fact, that forgers are denied the access to sensors used in the areas of a high security category and with that the knowledge of the exact checking and evaluation methods used by these sensors.

As a result of this the forgers are not able to adapt their bank note forgeries in such a way as to take into account the sensors, in particular, employed by the central banks. As a result of this the creation of “perfect” forgeries, which would not be detected even when automatically checked in the central banks, can be effectively prevented.

Different examples for the realization of this system are explained in detail in the following, the advantageous use of which is also possible when combined with each other.

The excitation radiation E, which is used for the simplified mode and the complex mode respectively, does not necessarily have the same wavelength. Preferably, the excitation radiation is an IR— or an UV-radiation. Radiation of different wavelengths, depending on the mode, can also be employed.

According to an idea of the present invention there can also be provided, that the light sources 20 excite at different wavelengths. The light source can also be used for exciting the luminescence in different feature substances, contained in the substrate 10 as a combination, at the wavelength most appropriate in the individual case. Preferably, for that purpose are used light sources 20, which significantly emit only in spaced-apart wavelength ranges.

### Example:

If the security feature 100 is e.g. a combination of Eu:BaMg₂Al₁₁O₂₇ (emission maximum at approx. 430 nm) and Ce:YAG (emission maximum at approx. 500 nm, very broad band), there can be provided, that the reading devices which are used in the areas of a low security category, such as e.g. in vending machines, measure the response signal, i.e. the emitted luminescence radiation, only when excited with the wavelength λ=365 nm, and compare it to the reference signal specific for this excitation wavelength.
In contrast to that, there can be provided, that only those reading devices which are employed in areas of a higher security category, such as e.g. in central banks, measure the emitted luminescence radiation at another excitation wavelength λ of e.g. 254 nm and compare it to the reference signal specific for this excitation wavelength.
By restricting the information about the wavelength at which the high-security reading devices do excite to this high-security area, and due to the fact that the forger cannot gain any information, when using the more easily accessible reading devices of a lower security category, about the fact that the central banks measure the luminescence radiation at 254 nm, the creation of “perfect” forgeries is made significantly more difficult.

As already mentioned the luminescence feature 100, according to a further idea of the present invention, comprises e.g. at least two luminescent materials, which produce respective luminescence spectral bands as a response when excited by an excitation radiation E.

The actually measured spectral bands have a certain non-vanishing width even when using the highest-quality sensors, the individual spectral bands not yet being blurred to one continuous spectrum and thus the details of the spectrum being preserved. When reducing the resolution even further, all that remains is the broad-band envelope (dotted line) as shown in FIG. 4.

This envelope represents a simplified, broad-band response signal, while the individual frequency-resolved representation of the individual spectral bands can be seen as complex representation of the same response signal. The resolution of the simplified, broad-band response signal is of such a low degree, that the individual spectral bands of the response signal are not resolved, and merely the response signal averaged across a given wavelength range is measured.

I.e. the response signal of the feature can be measured according to the present invention:
as a simplified representation of low resolution, which shows a broad-band spectrum merely as an envelope without resolving the individual spectral bands, or
as a complex representation, which shows the individual spectral bands in a frequency-resolved fashion. Furthermore, it is possible, that this complex representation of the response signal of the feature resolves only some of the spectral bands, which are in fact contained in the response signal, or even only one of this spectral bands.

According to this it is possible to measure the luminescence feature as follows:
in a simplified mode, which corresponds to a lower security category and is employed e.g. in sensors for vending machines, wherein the response signal is read only as broad-band spectrum and compared to a simplified representation of the expected response signal, which is represented by a broad-band spectrum and/or
by a complex mode, which corresponds to a higher security category and e.g. is only employed in the sensors of central banks and/or commercial banks, wherein at least one of the spectral bands of the response signal is read in an individual frequency-resolved fashion, and the response is compared to a more complex, i.e. higher resolved, representation of the expected response signal, which at least comprises one spectral band.

Beside these two modes there can exist further modes corresponding to different security categories. E.g. sensors which measure with higher spectral resolution and/or which measure a larger number of individual spectral bands than sensors which are provided for commercial banks or for the producers of vending machines, are provided only for central banks.

The simplified mode requires only a simple detector and can be carried out e.g. with a low-cost broad-band sensor, whereas the complex mode can be carried out only with a higher resolving detector, which is also able to identify individual spectral bands of the response signal.

One of the further modes e.g. is the following case, in which the central bank can ascertain the response signal as a completely highly-resolved spectrum across the whole measurable wavelength range. The commercial banks e.g. would only be able to resolve a first spectral partial area, while in a second spectral partial area they could measure the presence or absence of a signal, but they would not be able to resolve it. The producers of vending machines or tills would e.g. only be able to receive information about the second spectral partial area. Advantageously, the last-mentioned group may also only be able to measure the presence or absence of a signal but not to resolve it.

### Example:

If the security feature 100 is e.g. a combination of Eu:SrB₄O₇ with spectral band at 370 nm and Pb:BaSi₂O₅ with spectral band at 350 nm, there can be provided, that only the reading devices employed in the central banks use a spectrometer with a resolution of a few nanometres, so as to be able to determine, that the two substances are present in the security feature.
Commercial banks or producers of vending machines will be provided only with reading devices with spectrometers that can determine merely the existence of a luminescence of approx. 360 nm, but not the spectral shape, and in particular are not able to differentiate between Eu:SrB₄O₇ and Pb:BaSi₂O₅.
If, alternatively, the reading devices of the commercial banks and producers of vending machine are equipped with a spectrometer, then this is provided with a distinctively lower resolution, e.g. 30-50 nm, so that a differentiation of the spectra of the security feature, i.e. the spectra of Eu:SrB₄O₇ and Pb:BaSi₂O₅ cannot be effected. The information about the combination of overlapping spectra by this means remains restricted to the area of the central bank.
Since a forger usually has access only to such detectors, which, according to the simplified mode, measure only with a lower resolution, the inventive proceeding makes the forging of the security feature by forgers distinctively more difficult.

As already mentioned, the determination of the spectral course with different resolutions can be achieved on the one hand by providing reading devices 1 for the different areas of use, which have a different resolution e.g. due to differently designed diffraction gratings. The different sensor parameters, therefore, are caused by the different design of the reading devices 1.

Alternatively, it is also possible, that the reading devices 1 provided in the different areas of use in principle are of the same design and e.g. also have identical diffraction gratings, the different measuring accuracy only being present in a different evaluation of the measured signals. This can e.g. mean that software-controlled in the processor unit 31 of the detector 30 of a lower security category for carrying out the simple checking mode only the measured values according to the curve 16 of FIG. 5 are evaluated, while the software of the processor unit 31 of the detector 30 of a higher security category for carrying out the complex checking mode evaluates the spectrum according to the graph 15 of the FIG. 5.

In other words, the simplified mode thus can be carried out also by the higher-resolving detector, by converting, in this case, the response into a broad-band signal (e.g. by a resolution-reducing folding) before the signal is compared to the simplified representation stored as reference signal. Therefore, in the sensor has to be deposited not the high-resolution reference signal, but only the broad-band signal which is less critical with regard to security.

Here, preferably, there can be also provided, that the different sensor parameters, i.e. the simple or complex checking mode, are released depending on the security category of the area of use. A sensor producer can offer, for example, reading devices 1 with detector 30 and processor unit 31, which can carry out both the complex checking intended for the high security area as well as the simple checking intended for the area requiring lower security.

Since the releasing is effected by means of software, for each different area of use certain software functions of the processor unit 31 can be released or locked, so that for example only in the area of a high security category the measuring of luminescence can be carried out with a high resolution (e.g. curve 15 in FIG. 5) and in the area of a low security category only a measuring with a low resolution (e.g. curve 16 in FIG. 5) can be carried out. Particularly in this case, the reference signal is deposited preferably in an encoded form in the sensor.

### Example:

With the above-mentioned example of a security feature 100 made of Eu:SrB₄O₇ and Pb:BaSi₂O₅ e.g. in all pertinent reading devices spectrometers with a resolution of 2 nm will be used, but only in the reading devices employed in the central banks an evaluation software is installed, which then actually evaluates the measured values obtained with this resolution. All other sensors will have an evaluation software in the processor unit, which transforms the data measured with the high resolution of 2 nm into a lower resolution and not until then evaluates.
Since as in all other examples the evaluation software usually is stored encoded in the reading device, the forger is not able to obtain exact details on the composition of the security feature 100 by using reading devices designed for the low security.

Furthermore, it is of advantage, when an authorization has to be effected at least in the event when the reading device 1 shall carry out a checking according to the higher security category. This can apply to both, reading devices with releasable software functions as well as reading devices which exclusively can carry out checkings according to the higher security category.

### Example:

For the purpose of authorization here e.g. the security category of a user of the reading device 1 can be checked. This user can authorize himself e.g. by chip cards, a biometric identification or a PIN-entry.

In the complex mode the reading unit of the reader preferably comprises several narrow-band detectors, each narrow-band detector being adapted to the detection of a part of the response signal in a narrow-band region of the spectrum.

Consequently, in the complex mode the response is read as a sum of narrow-band response signals. The respective narrow-band wavelength ranges of which the spectrum is composed, can cover a wavelength spectrum in a continuous or discontinuous fashion, i.e. only in a regional fashion. Preferably, a narrow-band wavelength range is of a 10 nm width.

In the complex mode, which corresponds to a higher security category, consequently the response signal is represented, particularly preferred, as an amount of narrow-band response signals, each narrow-band response signal being measured by an individual narrow-band detector.

In the complex mode at least one spectral band of the response signal R is individually measured and the narrow-band response signals R are compared to a complex representation of the expected response signal, which is formed by expected narrow-band response signals and at least comprises one spectral band, i.e. to a reference signal, which has a higher resolution than the respective reference signal of the simple mode.

In both modes (simplified and complex) the substrate is illuminated with at least one excitation radiation E, the luminescence response of the security feature to this excitation radiation is measured and the response signal is compared to the expected representation, i.e. to the expected reference signal of the response signal (the representation here is simplified or complex, depending on the mode).

By comparing the measured response signal R to the stored representation (simplified or complex), the authenticity of the information contained in the response signal R can be identified and thus the authenticity of the checked bank note 10 verified.

### Example:

If the security feature 100 is e.g. a combination of Er:CaF₂ with a spectral band at 845 nm and Er:YAG with a spectral band at 862 nm, there can be provided, that only in the reading devices employed in the central banks two narrow-band detectors with filters are used for carrying out the complex checking mode, which each measure in a spectral region of a width of approx. 15 nm. The first narrow-band detector here measures in a range of 840 to 855 nm and the second narrow-band detector in a range of 855 to 870 nm.
By evaluating the signals of these two narrow-band detectors, such as e.g. by determining the relation of the signal intensities of the two narrow-band detectors to a predetermined reference value, the authenticity of the bank note can be concluded.
When the sensors employed in vending machines, however, only measure the envelope without measuring the exact relation of the signal intensities ranging from 855 to 870 nm to the signal intensities ranging from 840 to 855 nm, the forger, who at most can gain access to the sensors employed in vending machines, cannot recognize, that the exact adjustment of the signal relation within the ranges from (840 to 855 nm) to (855 to 870 nm) represents a particular and exactly to be observed authenticity feature of the security feature 100 of the bank note 10.

As already mentioned, when evaluating the response signal R, on the one hand the measured response signal can be compared to an expected response signal, so as to check the authenticity of the bank note 10.

On the other hand the response signal can represent a further information, which is also connected to the substrate 10, as e.g. the denomination or the serial number of a checked bank note 10. Only if the measured response signal corresponds to the expected response signal and, additionally, the further information e.g. denomination-specific information represented by the response signal, corresponds to the denomination known because of other checks, the authenticity of the substrate 10 is confirmed.

### Example:

If the security feature 100, optionally in combination with other substances, has Mn:Zn₂SiO₄ with a spectral band at 520 nm and Ce:YPO₄ with a spectral band at 380 nm, there can be provided, that the quantity ratio between Mn:Zn₂SiO₄ and Ce:YPO₄ and therefore the pertinent response signals is denomination-specifically differently chosen.
When the reading device of the central banks has concluded e.g. from a checking of the printed image and/or the dimensions of the bank note 10, its denomination, there can be checked, whether the ratio of the signal intensities at 380 nm to 520 nm in fact corresponds to the quantity specific for the denomination determined before. If not, it is a forgery.

### Example:

However, also with the last-mentioned example at first there can be concluded the denomination from determining the ratio of the signal intensities at 380 nm to 520 nm and, optionally, only then other evaluations, e.g. a determination of denomination by means of other checks are carried out.

### Checking of an Encoded Luminescence Feature

In particular in the simple mode, which is employed in areas of a lower security level, there can be provided, that the detector employed in this area reads the encoded spectrum or the encoded spectra (excitation spectrum and/or emission spectrum) and checks, whether it is a certain spectral signature, i.e. one of several codes possible with bank notes, whereas, however, it is not possible to ascertain which of the several possible encodings in fact is present.

### Example:

E.g. in this simple mode there can be checked, whether the form of the envelope of the total spectrum measured with low spectral resolution (e.g. according to the dotted line in FIG. 4) has a predetermined course, without being able to conclude the kind of the individual spectral bands P and therefore not being able to conclude, which encoding in fact is present out of several possible encodings suitable for this envelope.

In other words, in particular in the simple mode, the encoding can be determined (only) partially, i.e. checked whether the read encoding is assignable to a partial amount (i.e. family) of predetermined encodings of real bank notes, whereas it is not determined, which exact encoding it is.

### Example:

With the example of a security feature 100 made of Eu:YVO₄ (632 nm), Mn,Pb:CaSiO₃ (610 nm) and Mn:KMgF3 (596 nm) with an overlapping spectrum by 600 nm, the quantity ratios of the individual substances for different encodings can be differently chosen.
A high-security reading device, which is employed in a central bank and works with a resolution of e.g. 10 nm and therefore can differentiate between the individual spectral bands of the three substances, can exactly differentiate the ratio of the signal intensities of the three individual spectral-bands wavelengths of 596 nm, 632 nm and 610 nm. Because of this with such a reading device the individual encodings, which are e.g. denomination-specific, can be differentiated.
For commercial banks, e.g., however, only such sensors are provided, which measure or evaluate with a resolution of only 50 nm and which therefore can merely determine the presence of a luminescence in the area of approx. 600 nm and thus the presence of an encoding possible for this encoding system, but they are not able to differentiate between the individual encodings.

As already mentioned, in the complex mode, i.e. when checking in the areas of a high security level, there can be provided that the exact code is determined by measuring the response signal R in an exactly enough fashion, so as to be able to assign it to a predetermined encoding of real bank notes or to determine, that it is not an encoding of real bank notes.

### Two-Wavelength-Range Detection

The measuring of the response signal R can be effected—irrespective of whether carried out in simplified or complex mode—in different wavelength ranges.

FIG. 3 for example shows the two wavelength ranges D1 and D2. FIG. 3 shows a schematic representation of a further example of a response signal R, i.e. the signal intensity dependent on the wavelength of the emission spectrum of the feature 100 when respectively excited. This spectrum has luminescence spectral bands P at certain wavelengths. The spectral bands, as schematically shown in FIG. 3, are idealized spectral bands, without any width along the horizontal wavelength axis. A real response would, according to the example of FIG. 4, show spectral bands, which of course have a certain width and spectrally overlap each other.

### Example:

The border between the wavelength ranges D1 and D2 preferably is defined by the band edge of a silicon detector. This band edge lies at approx. 1100 nm. Silicon detectors are easily accessible and well proven, while for higher wavelengths above the band edge of silicon detectors, substantially more complicated and expensive detection technologies have to be employed. Furthermore, these are difficult to access, which is of benefit to the protection from forgery.
The simplified representation of the response signal R preferably extends beyond the band edge of a silicon detector.
In these cases the sensor unit of the detector should be adapted (both when using them in simplified or in complex mode), so as to be able to completely read the wavelength spectrum of the response signal R.

In the foregoing-mentioned case of the simplified representation of the response signal R, a forger, who has a silicon detector, would measure a feature, whose response signal has a broad-band envelope, the latter being restricted to the spectral area in which silicon detectors are sensible.

In this case the forger would not even be able to completely measure the simplified representation of the expected spectrum.

Alternatively, the simplified representation of the response signal R consists of at least two simplified representations of an expected response signal, each simplified representation of the expected spectrum being defined for a respective, preferably spaced-apart from each other wavelength range.

For example it is possible to view two simplified representations, one lying in a first area below a threshold value and the other in a second area above the threshold value.

### Example:

The threshold value can correspond to the band edge of a usually available silicon detector.

The method described for the simplified mode can be carried out with the complex mode as well. Beside the difficulty to measure spectral bands beyond the band edge of a silicon detector, each individual spectral band additionally has to be measured as such in a frequency-resolved fashion.

Consequently, it is possible to store a complex representation of the response signal R as one single spectrum, but also as at least two complex representations D1, D2 of the expected response signal with high frequency resolution, each complex representation of the response being defined for a certain, preferably spaced-apart from each other wavelength range.

As to further illustrate the present invention, FIG. 5 schematically shows the luminescence spectrum R of the same feature 100, measurable with two different detectors 30 with different spectral resolution, i.e. the dependence of the measured radiation intensity I on the wavelength λ of the luminescence radiation. The continuous curve 15 shows the luminescence spectrum R measured with higher resolution and the dotted curve 16 the luminescence spectrum R measured with lower resolution.

### Example:

The feature to be checked shall be a mixture of two luminescent sub-stances A and B. In the shown spectral region the substance A by way of example shall have a main maximum at λ_{A1} and a secondary maximum at λ_{A2}. The substance B in the shown spectral region shall have merely a single maximum at a wavelength λ_{B1}, which in spectral terms shall only be slightly distanced from the maximum λ_{A1} of the component A. In the area of the wavelengths λ_{A1} and λ_{B1} the two substances A and B thus have a strongly overlapping spectrum.
This spectral overlapping of the substances A and B leads to the fact, that only when measuring with a higher resolution, according to the curve 15, the fine structure of the measuring curve in the area of the wavelengths λ_{A1} and λ_{B1} can be captured. When measuring according to curve 16 with a lower resolution, which cannot capture the differences of the intensity I in the area between the wavelengths λ_{A1} and λ_{B1} in a resolved fashion any more, merely the envelope of the total spectrum 16 is measured, without being able to determine any details about the fine structure of the spectrum, such as e.g. the different maximums at λ_{A} and λ_{B}.

This has the effect, in particular in the case of the luminescence intensity of the substance B in the area of the wavelength λ_{B1} being distinctively lower than that of the substance A in the area of the wavelength λ_{A1}, that only when measuring with higher resolution (curve 15) there can be differentiated between the cases of the checked feature substance containing not only the substance A, but also the substance B.

Thus, preferably only when checking according to a higher security category, a spectral separation, i.e. a determination of the single components A, B in a luminescence feature consisting of several different substances, will be effected.

If according to the invention for users in areas of a high security category the reading devices with higher resolution are provided, and if for users in areas with a lower security category only the reading devices with lower resolution are provided, then merely in those areas of use with a high security category the differentiation between the single substances A and B with strongly overlapping spectrum can be made, while such a differentiation is not possible with the lower resolution according to the measuring curve 16.

This leads to the fact, that only in the areas of use with a high security category the information about the existence of two different substances A and B in the bank notes to be checked can be gained, while for reasons of lower measuring accuracy in the area with a lower security category this information inherently cannot be recognized.

If the different reading devices 1 for carrying out the simple or complex mode shall not only measure with different spectral resolution depending on the security category, but additionally or alternatively also in other spectral regions, with the special example in FIG. 5 there can be provided, that only a reading device 1 with high security category can measure in a wavelength range dλ_{H}, which can capture the main maximum λ_{A1}, λ_{B1} as well as the secondary maximum λ_{A2} which is spectrally spaced-apart thereto.

Contrary to this there can be provided, that all reading devices 1 of a low security category can only measure or evaluate in a smaller wavelength range dλ_{N}, in which the secondary maximum of the wavelength λ_{A2} is not contained. Since this measuring range is excluded, a forger can conclude from an otherwise maybe possible comparing of the relative intensities of the maximums at λ_{A1} and λ_{A2} neither the actual existence of the substance A nor the substance B. This would only be possible, if the intensity ratio (I(λ_{A1})/I(λ_{A2})) could be determined, which significantly changes with the presence or absence of an addition of the substance B. Due to the similar spectral behaviour when measuring with low resolution and the constricted spectral measuring range dλ_{N}, a differentiation of the substances A and B, on principle, is not possible.

Because of this, the information, that the security feature of a real bank note BN contains both substances A and B and must have a maximum even with the wavelength λ_{A2}, remains restricted to the use in the high-security area.

### Example:

If the security feature 100 has e.g. among other things Mn:Zn₂SiO₄ with spectral band at 520 nm and Ce:YPO₄ with spectral band at 380 nm, there can be provided, that only the reading devices 1 of a high security category of the central banks measure in both wavelength ranges of 380 nm and 520 nm, while in the vending machines e.g. only reading devices of a low security category are used, which measure in a range of 450 to 550 nm.
Because of this the forger, who, at most has access to reading devices of a low security category, will not be able to conclude the existence of an addition of Ce:YPO₄, that emits at 380 nm, from an evaluation of the signals of this reading devices.

This further example shows, that the present invention is in particular advantageous for the checking of combined feature substances contained in the substrate 10, since the exact composition of these substances usually is kept secret more especially, so as to make the creation of forgeries more difficult.

### Alternative Checking Methods

In the foregoing some different checking methods have already been described. Additionally, however, further alternatives or amendments are thinkable.

According to a further idea of the present invention there can also be provided, that in a detector 30 a multistage checking is carried out. This can be effected e.g. by evaluating the measuring in the simplified mode with lower resolution in a first stage and, in a subsequent stage, evaluating the measuring in the complex mode with higher resolution.

In a first stage, for example, only the envelope 16 of the overlapping spectrum can be determined with low resolution (according to a measuring in the simplified mode), so as to carry out first evaluations. As to check e.g. a luminescence feature 100 consisting of several substances A, B with overlapping spectral bands, in a first stage only the general existence of luminescent sub-stances will be determined, such as e.g. the general existence of a certain group of substances and/or encodings, which in this stage of checking are still undetermined.

This can be effected, for example, by detecting e.g. only the existence of luminescence radiation in a specific spectral region.

If in this stage the expected response signals are not measured, the checking can be terminated.

Otherwise, in a second stage (according to a measuring in the complex mode) the overlap of the response signal is actually proven. I.e. it is determined, whether it is in fact one of the predetermined spectra, which each consists of several single spectra of the individual substances of the luminescence feature, which overlap each other. This can be effected, for example, by at least one spectral band or several spectral bands of the response signal R (e.g. according to a complex representation the single spectral bands of the curve 15 in FIG. 5) being captured in a resolved fashion and checked.

### Example:

In the foregoing there has been described the example of a security feature 100 containing Eu:YVO₄ (632 nm), Mn,Pb:CaSiO₃ (610 nm) and Mn:KMgF₃ (596 nm), in which the quantity ratio of the individual sub-stances for different encodings is chosen differently.
It may be assumed, that the reading device employed in central banks has a spectrometer, that works with a resolution of e.g. 15 nm, and thus can differentiate between the individual spectral bands of the three substances. Furthermore, it may have a broadband detector with a filter, which e.g. integratedly measures within the range of 550 to 640 nm.

From the mere quick evaluation of the signal of the broadband detector then can be concluded a forgery, if its signal lies below a predetermined reference value. Then the subsequent stage is no longer necessary, in which in an elaborate way the signal intensities of the spectrometers at the three wavelengths of the individual spectral bands 596 nm, 632 nm and 610 nm and their ratio to each other are determined. Due to this the evaluation can be accelerated.

Furthermore, in the foregoing it was mentioned, that the measurements in the simple or the complex mode can be carried out in several different spectral regions. In particular in this case there cannot only be provided, that the excitation for all luminescence wavelength ranges is effected with different excitation wavelengths, but there can also be provided, that the excitation for all luminescence wavelength ranges is effected with the same excitation wavelength.

Furthermore, there can also be provided, that the excitation spectra are encoded, i.e. that the light source 20 does not emit constant signals, but a timely modulated excitation radiation E. With that also the response signals R are modulated in a way, that is characteristically for the individual feature sub-stances or feature substance combinations.

Furthermore, it shall be emphasized, that e.g. also with the measuring in the complex mode a high-resolution measuring in one wavelength range can be combined with a lower resolving measuring in another wavelength range. This can be employed, for example, as to individually determine only certain particularly significant feature substances within a combination of sub-stances forming the luminescence feature 100.

As already explained in detail in the foregoing, the present invention is characterized among other things by the fact, that for different security category areas different detectors are provided. In a low-security area the checking can be effected only in a simple mode, e.g. only the envelope of the response signal R is checked, while in the high-security area with a complex mode there can be ascertained e.g. also individual spectral bands P of the response signal R which are not recognizable when measuring the envelope.

However, it can also be provided, that depending on the area of use or the pertinent security category another property of the same feature 100 is checked.

### Example:

There can be provided, that with a use in a low-security area, such as e.g. in a vending machine, only certain optical properties of the feature substance can be checked, such as e.g. the envelope of the luminescence signal, whereas in high-security areas, i.e. e.g. in central banks, also other optical properties and/or other properties, such as e.g. magnetic properties, of the security feature 100 are checked.
Thus, for example, when combining a luminescence check with a magnetic check, only the reading device 1 with a higher security category can carry out this measurement of magnetism, or with a higher accuracy than the reading device of a lower security category.

As already mentioned, the measuring can be effected in different ways, not only by measuring with different accuracies, such as with different spectral resolution, or in different spectral regions. Depending on the security category, also a measuring can be effected in different areas of the bank note surface.

1. A system of value documents, comprising a large amount of individual documents being subdivided into defined subgroups, each subgroup having an invisible but machine-readable coding common for all individual documents of said subgroup, the codings of the different subgroups being different from each other, wherein said coding is a spectral coding being formed by at least two luminescent materials having overlapping spectral bands.

2. A luminescent security feature for improving the security level of a substrate, the feature being able to emit a luminescence response with information, and comprising at least two luminescent materials that produce corresponding, overlapping spectral bands as a response to an excitation radiation.

3. The security feature according to claim 2, wherein the luminescent material comprises at least one luminophore in a matrix.

4. The security feature according to claim 3, wherein the luminescent materials have different luminophores but the same matrix, or have different matrices but the same luminophore.

5. The security feature according to claim 4, wherein the different matrices are produced substantially from the same chemical elements and have different crystallographic configurations.

6. The security feature according to claim 4, wherein the different matrices have substantially the same crystallographic configuration but are produced from different chemical elements.

7. The security feature according to claim 3, comprising at least one inactive dummy matrix which is not combined with a luminophore, or which is combined with a luminophore in such a way that this luminophore does not show any luminescent properties, so that the inactive dummy matrix does not show any luminescence effect upon irradiation.

8. The security feature according to claim 7, wherein the inactive dummy matrix or matrices are different from the matrix or matrices combined with a luminophore.

9. The security feature according to claim 2, comprising at least two inactive dummy matrices, whereby the inactive dummy matrices form a code.

10. The security feature according to claim 2, wherein at least some spectral bands of the luminescent material form a code.

11. The security feature according to claim 2, wherein upon excitation the security feature emits partly in the spectral range below the band edge of a silicon detector and partly in the spectral range above the band edge of a silicon detector.

12. A substrate comprising a luminescent security feature according to claim 2.

13. A method for checking a luminescent security feature of a substrate comprising the following steps:
illuminating the substrate with at least one excitation radiation,
measuring the luminescence response signal from the substrate,
comparing the response signal with an expected response signal, wherein the measured response signal has overlapping spectral bands and the response signal is read according to at least one of the following procedures:
a simplified mode, corresponding to a lower security category, whereby the measured response signal is measured as a broad-band response signal and the response signal is compared with a simplified representation of the expected response signal with lower resolution, which is defined by a broadband spectrum, and
a complex mode, corresponding to a higher security category, whereby the measured response signal is measured as a set of narrowband response signals and whereby at least one of the spectral bands of the measured response signal is measured individually resolved, and the narrowband measured response signals are compared with a complex representation of the expected response signal with higher resolution, which is formed by the expected narrowband response signals and comprises at least one spectral band.

14. The method according to claim 13, wherein the complex representation of the expected response signal comprises more than one spectral band.

15. The method according to claim 13, wherein the complex representation of the expected response signal comprises a code based on the spectral bands of the complex representation of the expected response signal.

16. The method according to claim 15, wherein the code is based on the corresponding wavelengths of the spectral bands in the expected response signal.

17. The method according to claim 15, wherein the code is based on the corresponding intensities of the spectral bands in the expected response signal.

18. The method according to claim 13, wherein the simplified mode is executed by detecting at least one simplified representation of the expected response signal.

19. The method according to claim 18, wherein the at least one simplified representation of the expected response signal lies in the spectral range below the band edge of a silicon detector.

20. The method according to claim 18, wherein the at least one simplified representation of the expected response signal comprises the spectral range of the band edge of a silicon detector.

21. The method according to claim 18, wherein the simplified mode is executed by detecting at least two simplified representations of the expected response signal in different, preferably spaced wavelength ranges.

22. The method according to claim 13, wherein at least one simplified representation of the expected response signal is defined in a first wavelength range below the band edge of a silicon detector, and another simplified representation of the expected response signal is defined in a second wavelength range lying at least partly above the band edge of a silicon detector.

23. The method according to claim 13, wherein the complex mode is executed by detecting at least one complex representation of the expected response signal.

24. The method according to claim 23, wherein the at least one complex representation of the expected response signal comprises the spectral range of the band edge of a silicon detector.

25. The method according to claim 22, wherein the at least one complex representation of the expected response signal lies in a spectral range below the band edge of a silicon detector.

26. The method according to claim 13, wherein the complex mode is executed by detecting at least two complex representations of the expected response signal in different, preferably spaced wavelength ranges.

27. The method according to claim 26, wherein at least one complex representation of the expected response signal lies in a first wavelength range below the band edge of a silicon detector, and another complex representation of the expected response signal is present in a second wavelength range lying at least partly above the band edge of a silicon detector.

28. The method according to claim 13, wherein the wavelengths of the excitation radiation are different in the simplified mode and in the complex mode.

29. The method according to claim 13, wherein the excitation radiation includes IR radiation.

30. The method according to claim 13, wherein the expected response signal corresponds to information that enables authentication of the substrate by comparison with an expected response signal.

31. The method according to claim 13, wherein the expected response signal is specific to at least one of the denomination and a serial number of the substrate.

32. The method according to claim 13, wherein the expected response signal has one part in a first spectral range which is measurable with a first detection system, and has another part in another spectral range which is measurable with another detection system.

33. The method according to claim 32, wherein the first spectral range lies exclusively below the band edge of a silicon detector, and the second spectral range lies at least partly above the band edge of a silicon detector.

34. The method according to claim 13, including the steps of performing a multistage check is in a detector.

35. The method according to claim 13, wherein, using a detector, an evaluation of the measured response signal is performed with lower resolution in a first checking step, and an evaluation of the measured response signal in the complex mode with higher resolution in a subsequent checking step.

36. The method according to claim 13, wherein, using a detector, only the general existence of a luminescent security feature comprising several substances with overlapping spectra is checked in a first checking step, and at least one of the substances of the luminescent security feature is determined in a subsequent checking step.

37. The method according to claim 13, wherein the luminescent security feature is excited by one or more light sources at different wavelengths.

38. The method according to claim 13, wherein the luminescent security feature is excited to luminesce by a time modulated excitation radiation.

39. The method according to claim 13, wherein, upon measurement or evaluation of the measurement of luminescence radiation, measurement or evaluation is done in different wavelength ranges with different spectral resolution.

40. The method according to claim 13, wherein the security feature is a coding enabling distinction between different substrates, and only the existence or non-existence of a previously known coding can be checked in the simple mode, and the specific type of coding only in the complex mode.

41. The method according to claim 13, wherein, for checking luminescent security features of a substrate, said features are excited at different wavelengths in areas of a low security category compared to areas of a higher security category.

42. A method of producing a luminescent security feature, comprising the following steps:
separate synthesising of at least two luminescent materials having overlapping spectral bands (P),
grinding the materials to powdered pigments having the desired size,
mixing the pigments to get an homogenous mixture.

43. A method of producing a substrate having a luminescent security feature, comprising the following steps:
separate synthesising of at least two luminescent materials having overlapping spectral bands (P),
grinding the materials to powdered pigments having the desired size,
mixing the pigments to get an homogenous mixture and
depositing the mixture either or both in or on the substrate (10).

44. A method of producing a system of value documents according to claim 1, comprising the following steps:
selecting at least two luminescent materials for each subgroup to form a coding which is specific for the respective subgroup and
depositing the materials specifically selected for said subgroups in and/or on the individual documents of said respective subgroups.

45. The method of claim 44, wherein the step of depositing is monitored by measuring the coding.

46. A method of claim 45, wherein depending on the results of the monitoring the dosage of the luminescent materials is adjusted.

47. A reading device for checking a luminescent security feature of a substrate, comprising a detector for reading the response signal of the security feature upon excitation, wherein the detector comprises one or more units for measuring spectral bands above the band edge of a silicon detector.

48. The system according to claim 1, wherein the luminescent material comprises at least one luminophore in a matrix.

49. The system according to claim 48, wherein at least two luminescent materials have different luminophores but the same matrix, or have different matrices but the same luminophore.

50. The system according to claim 48, wherein the different matrices are produced substantially from the same chemical elements and have different crystallographic configurations.

51. The system according to claim 49, wherein the different matrices have substantially the same crystallographic configuration but are produced from different chemical elements.

52. The system according to claim 48, comprising at least one inactive dummy matrix which is not combined with a luminophore, or which is combined with a luminophore in such a way that this luminophore does not show any luminescent properties, so that the inactive dummy matrix does not show any luminescence effect upon irradiation.

53. The system according to claim 52, wherein the inactive dummy matrix or matrices are different from the matrix or matrices combined with a luminophore.

54. The system according to claim 1, comprising at least two inactive dummy matrices, wherein the inactive dummy matrices form a code.

55. The system according to claim 1, wherein at least some spectral bands of the luminescent material form a code.

56. The system according to claim 1, wherein upon excitation the system emits partly in the spectral range below the band edge of a silicon detector and partly in the spectral range above the band edge of a silicon detector.
